(19) United States
(12) Patent Application Publication
(10) Pub. No.: US 2026/0358630 A1
(43) Pub. Date: Nov. 12, 2026

(54) AN APPARATUS FOR PROJECTING IMAGES TOWARDS A VIEWING PLANE

(71) Applicant: Nokia Technologies Oy, Espoo (FI)

(72) Inventors: Toni Johan Järvenpää, Tampere (FI); Marja Pauliina Salmimaa, Tampere (FI)

(21) Appl. No.: 19/490,677

(22) PCT Filed: May 28, 2024
(86) PCT No.: PCT/EP2024/064618

§ 371 Date: Dec. 5, 2025

(30) Foreign Application Priority Data
Jun. 8, 2023 (GB) 2308545.9

(51) Int. Cl. G02B 27/01

(52) U.S. Cl. CPC G02B 27/0101; G02B 27/0179; G02B 2027/0123; G02B 2027/0187

(57) ABSTRACT

According to various, but not necessarily all, examples there is provided an apparatus comprising: image adjustment means comprising a reflector; and display means comprising an exit pupil expander comprising an out-coupling element configured to out-couple a first image to the image adjustment means and also to out-couple a second image toward a viewing plane. The reflector is configured to reflect the first image towards the viewing plane. An angle between the reflector and the out-coupling element is configured to direct the first image into a first area of the viewing plane and to direct light for at least partially constructing the second image into a second area of the viewing plane, the second area being outside of the first area. The apparatus also comprises means for adaptively cropping the second area in response to a user's eye position moving outside of the first area.

### TECHNOLOGICAL FIELD

Examples of the disclosure relate to an apparatus for projecting images towards a viewing plane. Some relate to apparatus for projecting images towards a viewing plane which is configured as an exit pupil expander head-up display, optionally a vehicle head-up display.

### BACKGROUND

Displays using exit pupil expanders can be used to project images towards a user. They are attractive because they can have a large exit pupil and therefore do not require exact positioning of a viewing user. However, a characteristic of exit pupil expanders is the outcoupling of light in two distinct directions. This can create unwanted duplicate or ghost images.

### BRIEF SUMMARY

According to various, but not necessarily all, examples there is provided examples as claimed in the appended claims.

According to various, but not necessarily all, examples there is provided an apparatus comprising: image adjustment means comprising a reflector; and display means comprising an exit pupil expander comprising an out-coupling element configured to out-couple a first image to the image adjustment means and also to out-couple a second image toward a viewing plane. The reflector is configured to reflect the first image towards the viewing plane. An angle between the reflector and the out-coupling element is configured to direct the first image into a first area of the viewing plane and to direct light for at least partially constructing the second image into a second area of the viewing plane, the second area being outside of the first area. The apparatus also comprises means for adaptively cropping the second area in response to a user's eye position moving outside of the first area.

In some but not necessarily all examples, means for adaptively cropping the second area comprises means for at least one of the following:
adaptively cropping an image for in-coupling into the exit pupil expander;
adaptively reducing an exit pupil expansion provided by the exit pupil expander; or
applying an adaptive spatial filter between the exit pupil expander and the viewing plane.

In some but not necessarily all examples, means for adaptively reducing an exit pupil expansion provided by the exit pupil expander comprises means for at least one of the following:
adaptively reducing an effective area of an expanding element of the exit pupil expander; or
adaptively reducing an effective area of the out-coupling element of the exit pupil expander.

In some but not necessarily all examples, an extent of the cropping of the second area is dependent on user's eye position.

In some but not necessarily all examples, the second area is cropped to exclude user's eye position.

In some but not necessarily all examples, the reflector is configured to reflect the first image back through the exit pupil expander towards the viewing plane.

In some but not necessarily all examples, the image adjustment means is configured to provide optical adjustment of the first image.

In some but not necessarily all examples, the image adjustment means is configured to compensate for distorting effects produced by a curved combiner used to reflect the first and second images toward the first and second areas respectively.

In some but not necessarily all examples, the reflector is curved to provide compensation for the distorting effects.

In some but not necessarily all examples, the image adjustment means comprises one or more additional optical elements disposed between the exit pupil expander and the reflector, wherein the one or more additional optical elements are configured to provide compensation for the distorting effects.

In some but not necessarily all examples, the angle between the reflector and the outcoupling element is configured to direct second and higher order reflections between the reflector and the exit pupil expander into a third area of the viewing plane, the third area being outside the first area.

In some but not necessarily all examples, the means for adaptively cropping the second area are also configured to adaptively crop the third area in response to a user's eye position moving outside of the first area.

In some but not necessarily all examples, the apparatus comprises means for obtaining or determining the user's eye position.

In some but not necessarily all examples, the apparatus is configured as an exit pupil expander head-up display, optionally a vehicle head-up display, wherein the display means comprises an optical engine and a combiner.

According to various, but not necessarily all, examples there is provided a method comprising: in response to a user's eye position moving outside of a first area into which a first image is directed, adaptively cropping a second area of a viewing plane into which light for at least partially constructing a second image is directed, the second area being outside of the first area. The first and second images are out-coupled in different directions from an exit pupil expander and are both directed towards the viewing plane. An image adjustment is applied to the first image.

According to various, but not necessarily all, examples there is provided a computer program comprising instructions which, when executed by an apparatus, causes the apparatus to perform at least the following: in response to a user's eye position moving outside of a first area into which a first image is directed, adaptively cropping a second area of a viewing plane into which light for at least partially constructing a second image is directed, the second area being outside of the first area. The first and second images are out-coupled in different directions from an exit pupil expander and are both directed towards the viewing plane. An image adjustment is applied to the first image.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

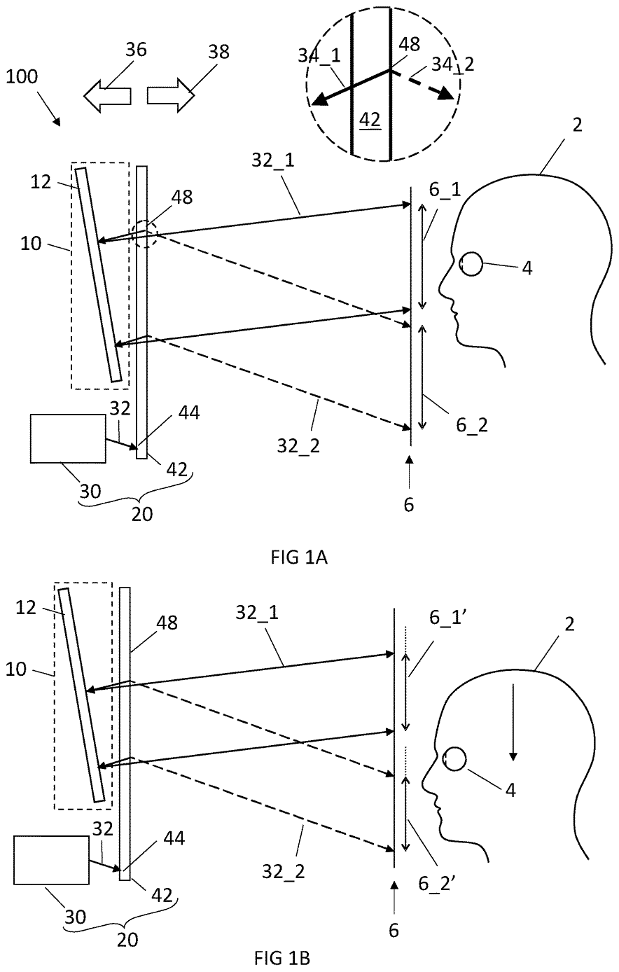

FIGS. 1A, 1B show an example of the subject matter described herein;

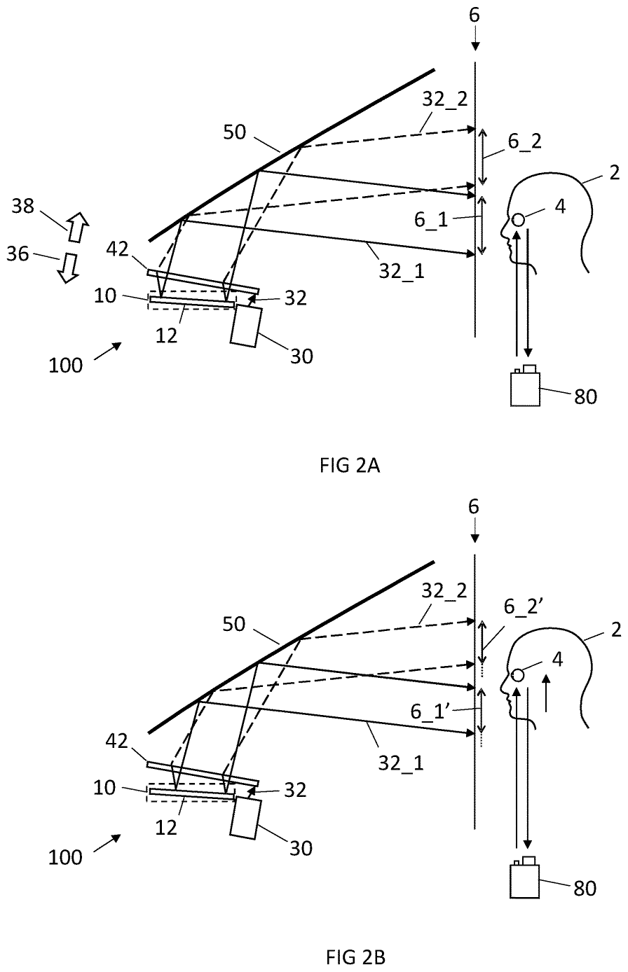

FIGS. 2A, 2B show another example of the subject matter described herein;

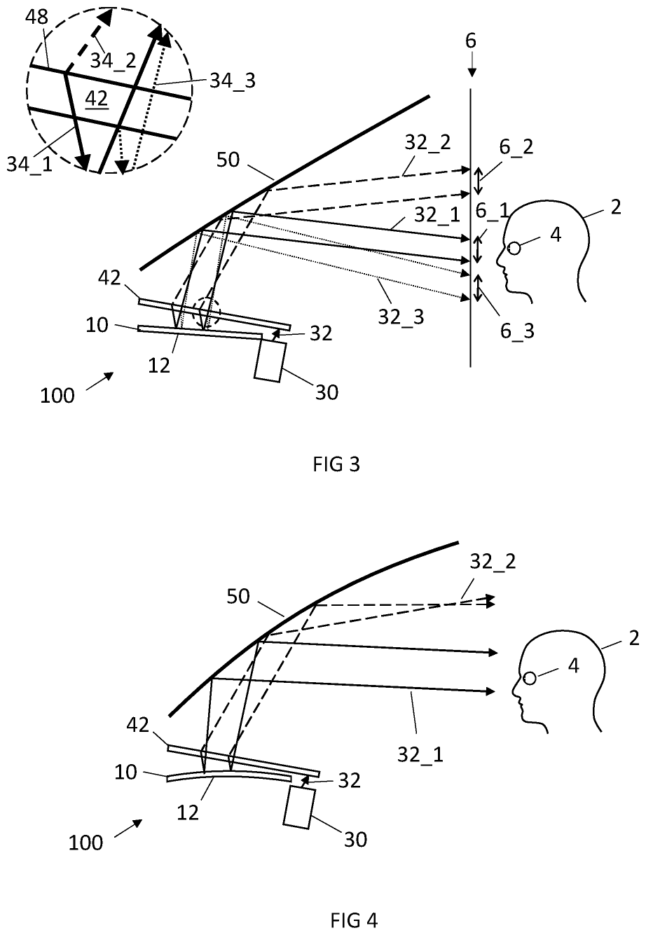

FIG. 3 shows another example of the subject matter described herein;

FIG. 4 shows another example of the subject matter described herein;

FIG. 5 shows another example of the subject matter described herein;

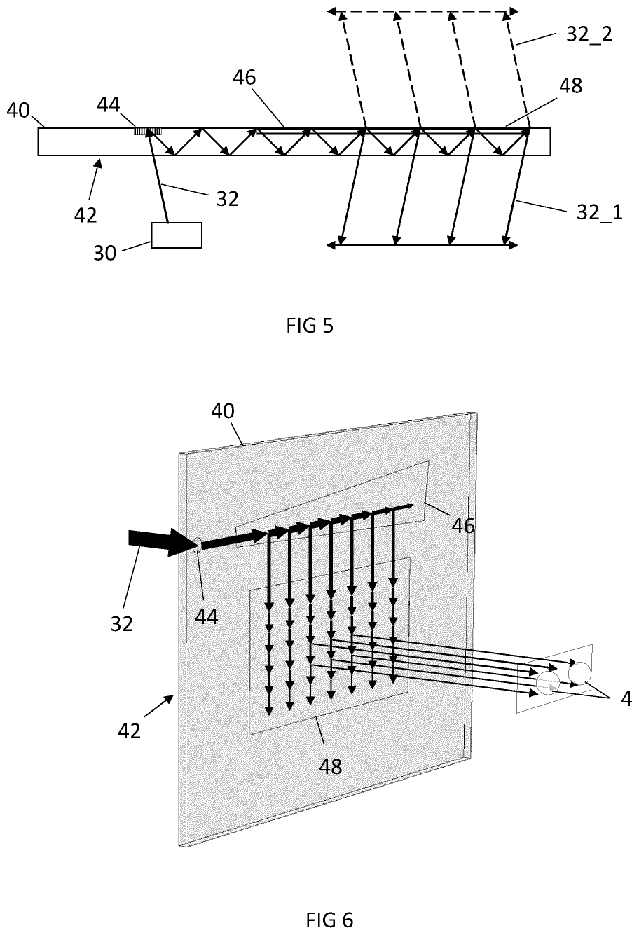

FIG. 6 shows another example of the subject matter described herein;

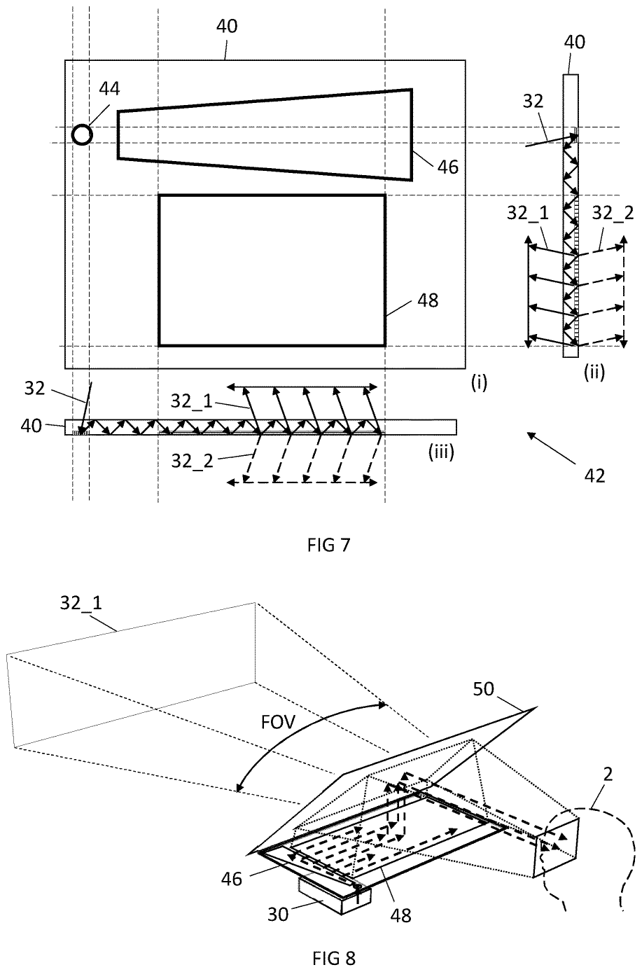

FIG. 7 shows another example of the subject matter described herein;

FIG. 8 shows another example of the subject matter described herein;

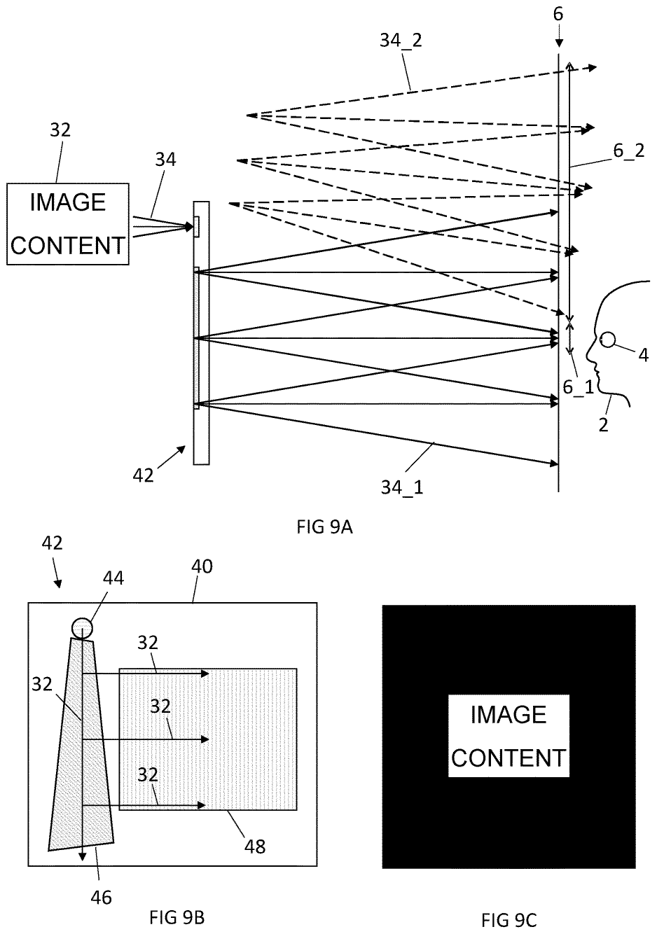

FIGS. 9A, 9B, 9C show another example of the subject matter described herein;

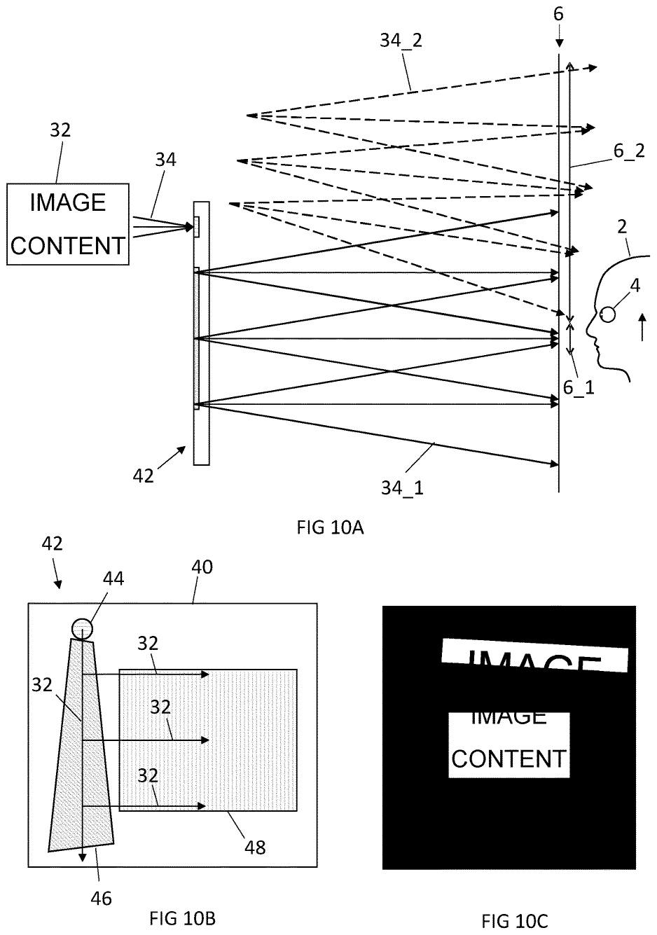

FIGS. 10A, 10B, 10C show another example of the subject matter described herein;

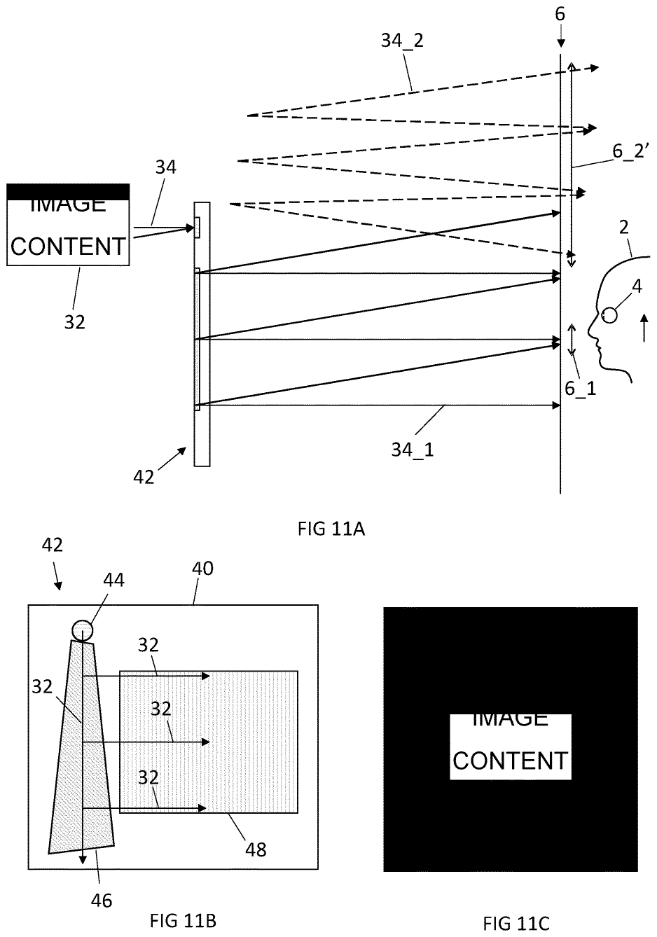

FIGS. 11A, 11B, 11C show another example of the subject matter described herein;

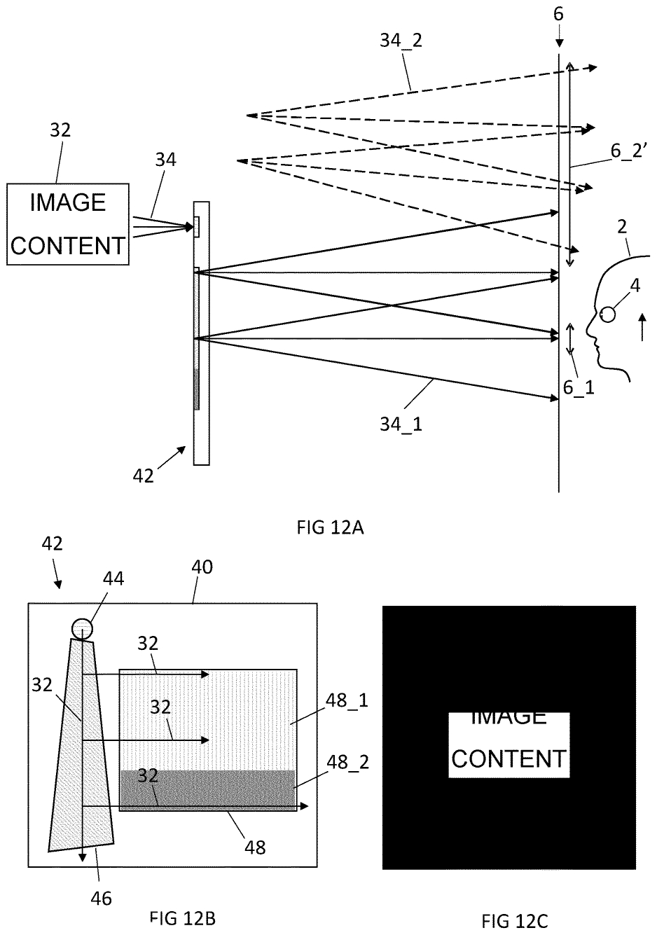

FIGS. 12A, 12B, 12C show another example of the subject matter described herein;

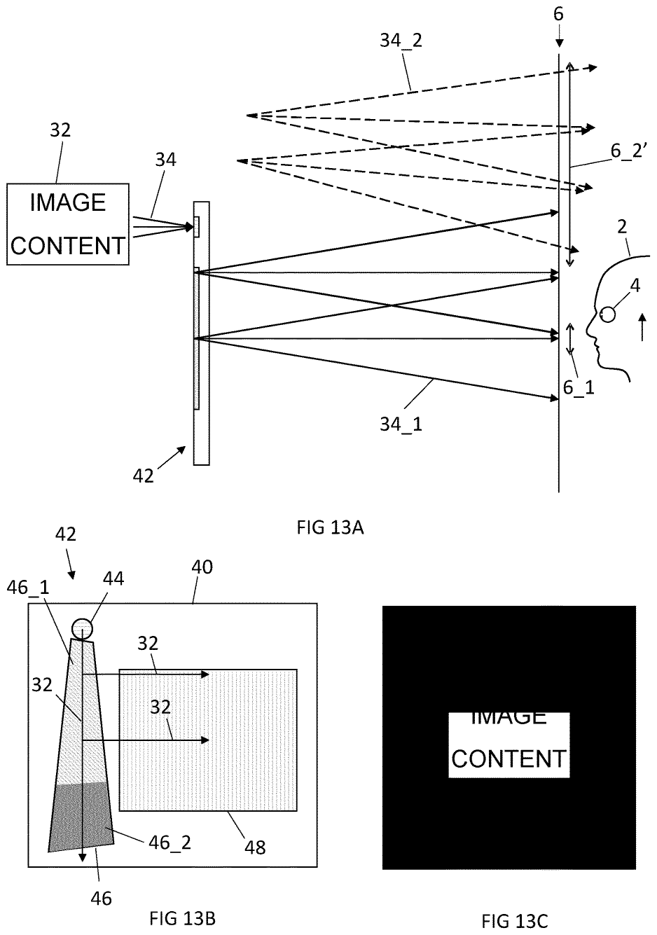

FIGS. 13A, 13B, 13C show another example of the subject matter described herein;

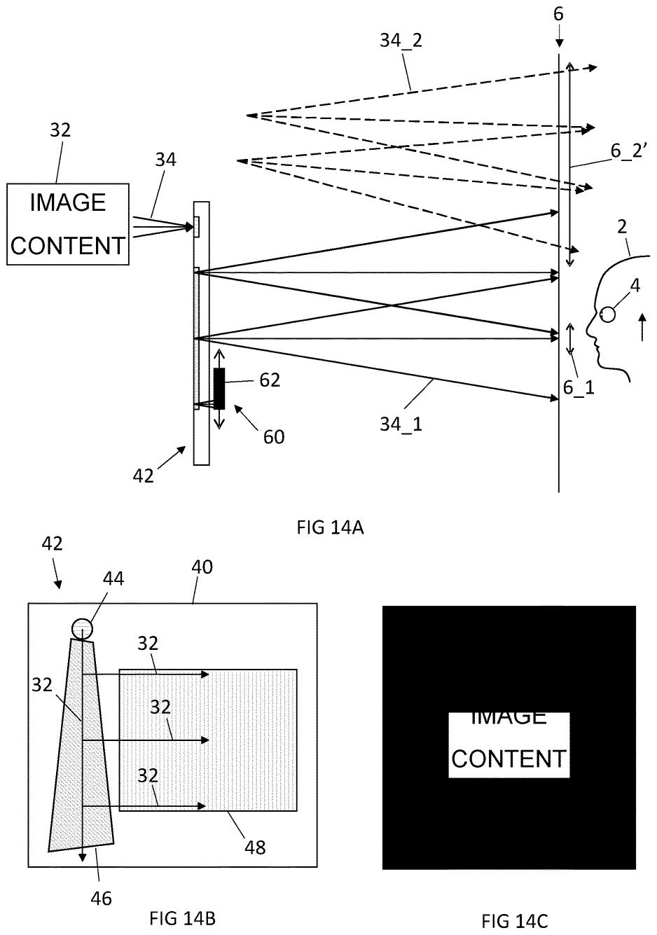

FIGS. 14A, 14B, 14C show another example of the subject matter described herein;

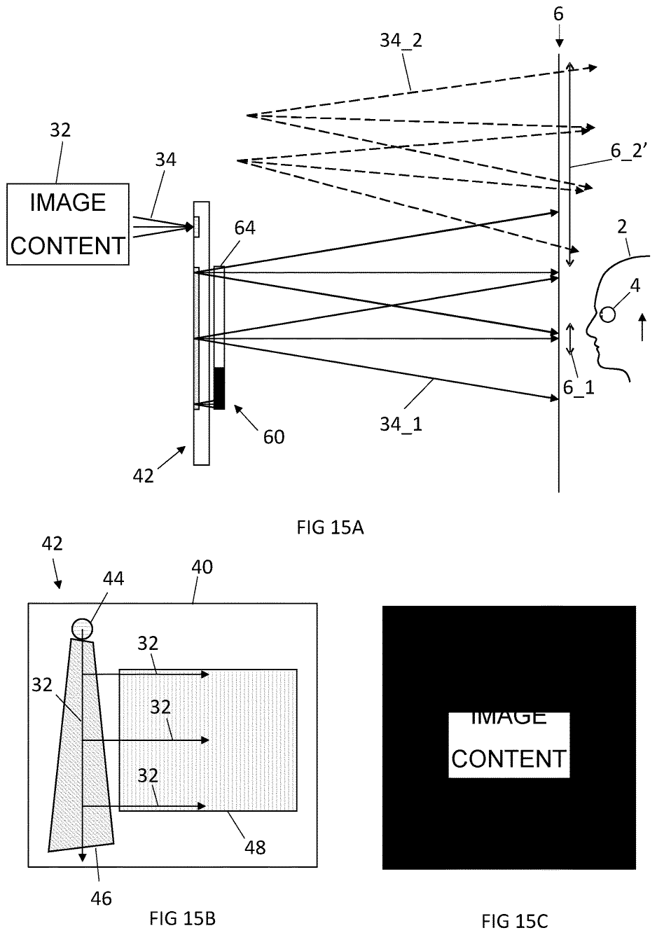

FIGS. 15A, 15B, 15C show another example of the subject matter described herein;

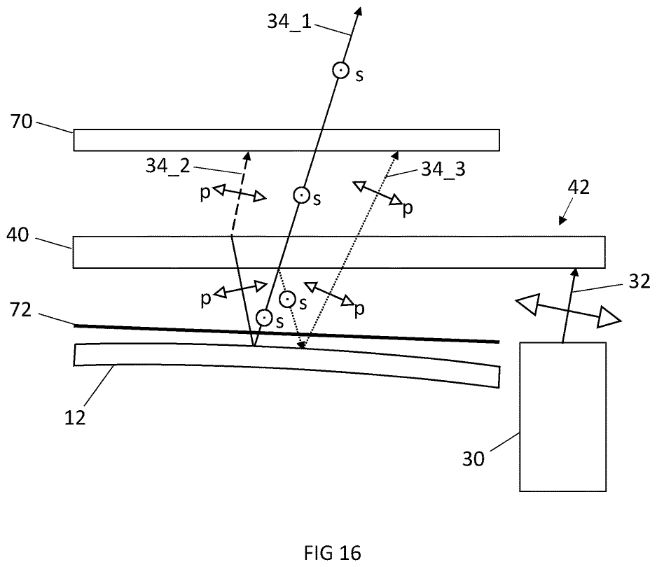

FIG. 16 shows another example of the subject matter described herein;

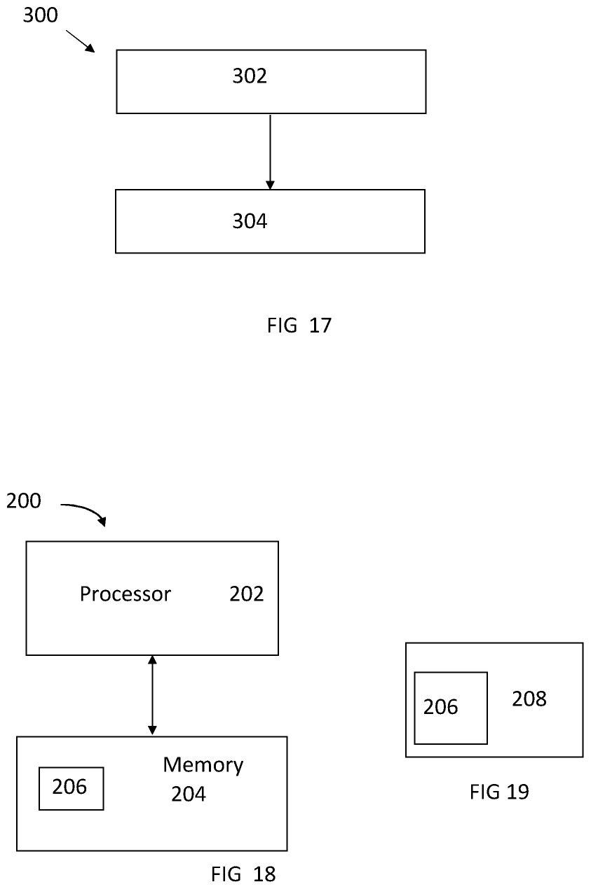

FIG. 17 shows another example of the subject matter described herein;

FIG. 18 shows another example of the subject matter described herein; and

FIG. 19 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

The following FIGs illustrate examples of an apparatus 100 for projecting visible light 34, forming an image 32, towards a viewing plane 6 for a user 2.

The apparatus 100 can be used for augmented reality. The apparatus 100 can be used as a head mounted display device or as a head-up display device. The apparatus 100, when configured as a head-up display device, can be housed in a vehicle or cab for a vehicle. Vehicles include trains, planes, automobiles, ships, spacecraft and other moving objects with a driver, pilot or human controller such as productivity vehicles, cranes. The apparatus 100, when configured as a head-up display device, can be housed in static workstations, tools and robots, and other windows or screens.

Referring to FIGS. 1A and 1B, the apparatus 100 comprises a display means 20 and an image adjustment means 10.

The display means 20 comprises an exit pupil expander (EPE) 42, examples of which are illustrated and described in greater detail in relation to FIGS. 5 to 7. The exit pupil expander 42 comprises an out-coupling element 48. The out-coupling element 48 causes visible light 34, which is in-coupled to the EPE 42, to outcouple from both sides of the EPE 42. The light 34 encodes an image 32.

Light 34 which is out-coupled in a “backward direction” 36 is referenced as 34_1 and encodes a first image 32_1 which can be seen when this light 34_1 reaches the eye(s) 4 of a user 2. Light 34 which is out-coupled in a “forward direction” 38 is referenced as 34_2 and encodes a second image 32_2 which can be seen when this light 34_2 reaches the eye(s) 4 of the user 2. The content of the out-coupled images 32_1, 32_2 is the same as the content of the in-coupled image 32. Accordingly, in the event that both of the out-coupled images 32_1, 32_2 reaches the eye(s) 4 of the user 2, the user may see duplicated or doubled images. The user 2 may perceive one of the out-coupled images 32_1, 32_2 as a ghost of the other.

The forward direction 38 is a direction of a forward optical path toward a viewing plane 6 for the user 2. “Towards a viewing plane 6″ in this context should not be understood as necessarily directly towards the viewing plane 6. In this context ”towards a viewing plane 6″ may also be understood to encompass a path indirectly towards the viewing plane 6 via one or more optical steering elements, that is one or more optical elements which are configured to steer light rays such as, for example, the combiner 50 shown in FIGS. 2A, 2B. Therefore, the forward direction 38 may be a direction in which lies the next optical steering element in a path leading towards the viewing plane 6. The viewing plane 6 refers to a plane which comprises a target exit pupil of the apparatus 100. The forward direction 38 is towards, directly or indirectly, this plane 6 rather than the target exit pupil specifically. The backward direction 36 is, correspondingly, a direction away from the viewing plane 6, either directly away from the viewing plane 6 or away from the next optical steering element in a path leading towards the viewing plane 6. The terms forward and backward should be interpreted accordingly.

In some examples the display means 20 comprises an optical engine 30 or is provided to an in-situ optical engine 30, for example to expand the exit pupil of the in-situ optical engine 30. The optical engine 30 is configured to represent a pixel of an image 32 as a beam of rays of light 34 that enter the EPE 42, via an in-coupling element 44, at a particular angle. Each ray of the in-coupled beam is split into a plurality of rays, each of which emerge at the same angle from different parts of the out-coupling element 48. In FIG. 1A a single in-coupled ray is illustrated and only the extreme positions of the corresponding out-coupled rays are illustrated, but these should be taken as representative of all rays and thus the image 32 as a whole. The optical engine can comprise any suitable light source, such as a display panel, and any suitable optics, such as projection lenses, which are designed to collimate the light 34 such that the light rays emanating from a particular pixel of the light source exit the optics as a parallel light beam at a particular angle to the in-coupling element 44. In some examples the optical engine 30 can be a picture generating unit (PGU) which operates as a projector and projects the image 32 into the EPE 42 using light 34.

The image adjustment means 10 is provided in a backward direction from the EPE 42 so that the backward directed light 34_1 is directed towards the image adjustment means 10.

The image adjustment means is configured to apply an adjustment to the first image 32_1 which is encoded by the backward directed light 34_1. In some examples, the image adjustment means 10 is configured to provide optical adjustment of the first image 32_1.

The optical adjustment leaves the image content unchanged. The optical adjustment can be a spatial or spectral transformation. That is, the image adjustment means is configured to apply a spatial or spectral transformation to the image content of the first image 32_1.

A spatial transformation may, for example, be configured to distort the first image 32_1 in a manner that is counter to distortion introduced by other optical element(s) in the path leading towards the viewing plane 6. Such a spatial transformation therefore has a compensatory effect.

A spectral transformation may, for example, be configured to adjust a ratio of intensities of different colours present in light 34_1. The white point (colour temperature) of the light 34_1 can be controlled to have a different white point (colour temperature) than when out-coupled from the EPE 42. In such examples, the image adjustment means could comprise a colour filter such as a tuneable wavelength selective colour filter.

The image adjustment means 10 comprises a reflector 10 which is configured to reflect the light 34_1 incident upon it back into the forward direction 38. Thus, at least some of the backward directed light 34_1 is recycled into the forward direction 38. Accordingly, the reflector 10 is configured to reflect the first image 32_1 towards the viewing plane 6.

Since the forward directed light 34_2 is not directed to the image adjustment means 10, no such optical adjustment is applied to the second image 32_2.

The reflector 12 comprises a reflective surface 14. The reflector 12, or at least its reflective surface 14, is not parallel with the out-coupling element 48 of the EPE 42, rather they are tilted with respect to one another, and therefore the forward directed light 34_2 and the recycled light 34_1 are directed to different areas of the viewing plane 6. Accordingly, there is an area of the viewing plane 6 in which the user 2 can see the first image 32_1, to which the image adjustment is applied, and not the second image 32_2, to which no such image adjustment is applied.

The angle between the reflector 12 and the out-coupling element 48 of the EPE 42 is configured to direct the first image 32_1 into a first area 6_1 of the viewing plane 6. Accordingly, when the user's eye(s) 4 are within the first area 6_1, it is possible for the user 2 to see the entire first image 32_1. It will be understood however that the recycled light 34_1 may also reach the viewing plane 6 outside the first area 6_1, though said light will be insufficient to fully construct the first image 32_1. Therefore, when the user's eye(s) 4 move outside of the first area 6_1, the user 2 may still see part, but not all, of the first image 32_1. From the user's perspective, the first image 32_1 will be subject to vignetting. For example, as their eye(s) 4 move upwards out of the first area 6_1, they may still observe a bottom part of the first image 32_1, but a top part will appear to have been cropped out. As their eye(s) 4 move downwards out of the first area 6_1, they may still observe a top part of the first image 32_1, but a bottom part will appear to have been cropped out. As their eye(s) 4 move leftwards out of the first area 6_1, they may still observe a right part of the first image 32_1, but a left part will appear to have been cropped out. As their eye(s) 4 move rightwards out of the first area 6_1, they may still observe a left part of the first image 32_1, but a right part will appear to have been cropped out. The first area 6_1 can correspond to a target exit pupil of the apparatus 100.

The angle between the reflector 12 and the out-coupling element 48 of the EPE 42 is additionally configured to direct light 34_2 for at least partially constructing the second image 32_2 into a second area 6_2 of the viewing plane 6. The second area 6_2 is outside of the first area 6_1. Where the first area 6_1 corresponds to a target exit pupil of the apparatus 100, the second area 6_2 is outside of this target exit pupil. The second area 6_2 may be located laterally from this target exit pupil. In some examples, some recycled light 34_1 may also reach the viewing plane 6 within the second area 6_2, though said light will be insufficient to fully construct the first image 32_1.

The angle between the reflector 12 and the out-coupling element 48 of the EPE 42 may be configured so that none of the forward directed light 34_2 reaches the viewing plane 6 within the first area 6_1. However, the second area 6_2 may be very close to the first area 6_1 and so some light 34_2 may accordingly end up very close to the first area 6_1. Therefore, when the user's eye(s) 4 move outside of the first area 6_1, without any further action by the apparatus 100, the user 2 may see at least part of the second image 32_2 in addition to part of the first image 32_1.

To avoid parts of the second image 32_2 being visible to the user 2, the second area 6_2 is adaptively cropped in response to a position of the eye(s) 4 of the user 2 moving outside of the first area 6_1. FIG. 1B illustrates an example where the user's eye(s) 4 have moved downward out of the first area 6_1, in which they were positioned in FIG. 1A. In response, the second area 6_2 has been adaptively cropped to provide a cropped second area 6_2′.

The cropping of the second area 6_2 may involve preventing any of the forward directed light 34_2 from reaching the viewing plane 6 outside of the cropped second area 6_2′. However, in some examples, it may be acceptable that part(s) of the second image 32_2 are dimly visible to the user 2, relative to the brightness of the first image 32_1. In such examples, the cropping of the second area 6_2 may involve reducing the brightness of any of the forward directed light 34_2 which reaches the viewing plane 6 outside of the cropped second area 6_2′.

An extent of the cropping of the second area 6_2 is dependent on the position of the eye(s) 4 of the user 2. In some examples the extent of the cropping of the second area 6_2 is dependent on the position of the eye(s) 4 of the user 2 relative to the first area 6_1. For example, the second area 6_2 may be cropped to exclude from the user's view the part of the second image 32_2 which corresponds to the part of the first image 32_1 that the user 2 can no longer see from their new position. In some examples the second area 6_2 is cropped to exclude the position of the eye(s) 4 of the user 2.

It is noted that in the example of FIG. 1B, the first area 6_1 has also ended up cropped such that the first image 32_1 is directed into a cropped first area 6_1′, no longer corresponding to the target exit pupil of the apparatus 100, however this may not be the case in all examples.

A variety of means for adaptively cropping the second area 6_2, to provide a cropped second area 6_2′, in response to the position of the eye(s) 4 of the user 2 moving outside of the first area 6_1 are described in relation to FIGS. 9A to 15C.

Means for obtaining the position of the eye(s) 4 of the user 2 may include means 80 (FIG. 2A) for determining the position of the eye(s) 4 of the user 2 or means for receiving a determined position of the eye(s) 4 of the user 2 such as a receiver or transceiver.

The adaptive cropping of the second area 6_2 is a suitable solution for avoiding parts of the second image 32_2 being visible to the user 2 regardless of the angle between the reflector 12 and the out-coupling element 48 of the EPE 42. For example, it is suitable when this angle is relatively small such that the reflector 12 is configured to reflect the first image 32_1 back through the exit pupil expander 42 towards the viewing plane 6, whereas other solutions such as absorbing the forward directed light 34_2, would not be suitable as they would also interfere with the recycled light 34_1 which encodes the first image 32_1.

FIGS. 2A and 2B illustrate a similar example to FIGS. 1A and 1B but wherein the display means 20 comprises a combiner 50 as well as the optical engine 30 and the exit pupil expander 42.

In this example, the forward direction 38 is towards the combiner 50 and the reflector 12 is configured to reflect the first image 32_1 towards the combiner 50.

The combiner 50 is configured to reflect the forward directed light 34_2 and the recycled light 34_1 towards the viewing plane 6. The combiner 50 is configured to direct the second image 32_2 into the second area 6_2 and to direct the first image 32_1 into the first area 6_1.

The presence of the combiner 50 may configure the apparatus 100 as an exit pupil expander head-up display, an example of which is described in greater detail in relation to FIG. 8.

In some examples, the combiner 50 is a windshield of a vehicle. The apparatus 100 may be configured as a vehicle head-up display.

Ambient (back) reflections are very hard to avoid when placing reflective surfaces below a windshield. There are certain orientations for the EPE 42 which allow for blocking of the ambient reflections (i.e. glare from sun, street lights). From the point of view of blocking ambient reflections, the reflector 12 should be parallel to the EPE 42. On the other hand, the larger the angle between the reflector 12 and the out-coupling element 48 of the EPE 42, the easier it is to create separation between the first area 6_1 and the second area 6_2. A suitable range of angles will be highly dependent on the application and the environment in which the apparatus 100 is used.

FIG. 2A also illustrates means 80 for determining the position of the eye(s) 4 of the user 2. The apparatus 100 may comprise the means 80 for determining the position of the eye(s) 4 of the user 2 or may receive the determined position of the eye(s) 4 of the user 2 from in-situ means 80 for determining the position of the eye(s) 4 of the user 2. In examples in which the apparatus 100 is housed in a vehicle, it may receive the 3D position of the eye(s) 4 of the user 2 from a vehicle-integrated camera-based tracking system or similar.

The means 80 for determining the position of the eye(s) 4 of the user 2 can comprise user tracking means such as an eye pupil position tracker, a head tracker, an eye tracker or some other similar tracking solution.

It will be understood that the means 80 for determining the position of the eye(s) 4 of the user 2 is not inextricably linked to the presence of a combiner 50 and can be provided in connection with any of the examples described in the foregoing or in the following.

In examples where the angle between the reflector 12 and the out-coupling element 48 of the EPE 42 is such that the first image 32_1 is reflected back through the exit pupil expander 42 towards the viewing plane 6, there may be second or higher order reflections between the reflector 12 and the exit pupil expander 42, as illustrated in FIG. 3. The image 32_3 encoded by light 34_3 which undergoes these second or higher order reflections is subjected to multiple applications of the image adjustment provided by the image adjustment means 10. This image 32_3 is therefore over adjusted. It will be noted that, of the image adjustment means 10, only the reflector 12 is shown in FIG. 3 to aid in the clarity of the illustration; nevertheless the image adjustment means 10 as a whole is present in the apparatus 100 according to this example.

To avoid the user 2 viewing the over adjusted image 32_3, the angle between the reflector 12 and the out-coupling element 48 is configured to direct light 34_3 which has undergone second and higher order reflections between the reflector 12 and the exit pupil expander 42 into a third area 6_3 of the viewing plane 6, the third area 6_3 being outside the first area 6_1. The angle may be configured so that the second and third areas 6_2, 6_3 are on opposite sides of the first area 6_1.

As with the forward directed light 34_2, some of the light 34_3 which has undergone second and higher order reflections may end up very close to the first area 6_1. The same means for adaptively cropping the second area 6_2 may therefore also be configured to adaptively crop the third area 6_3 in response to the position of the eye(s) 4 of the user 2 moving outside of the first area 6_1.

In the example of FIG. 3, the second area 6_2 is above the first area 6_1 and the third area 6_3 is below the first area 6_1. The second area 6_2 will therefore be adaptively cropped in response to the position of the eye(s) 4 of the user 2 moving upwards out of the first area 6_1 whereas the third area 6_3 will be adaptively cropped in response to the position of the eye(s) 4 of the user 2 moving downwards out of the first area 6_1. Some means for adaptively cropping these areas may result in both areas being cropped simultaneously.

It is to be appreciated that the light 34_3 which has undergone second and higher order reflections can be relatively dim compared to the forward directed light 34_2 and the recycled light 34_1. In some examples, therefore, it may be judged unnecessary to avoid this light 34_3 reaching the user 2 and the angle between the reflector 12 and the out-coupling element 48 may not be configured to direct light 34_3 which has undergone second and higher order reflections outside of the first area 6_1.

FIG. 4 illustrates an example in which the image adjustment means 10 is configured to compensate for distorting effects produced by a curved combiner 50 used to reflect the first and second images 32_1, 32_2 toward the first and second areas 6_1, 6_2 respectively.

In this example, the reflector 12 is curved to provide compensation for the distorting effects of the curved combiner 50. The reflector 12 has a curvature in opposing direction to the curved combiner 50. That is, if the curved combiner 50 presents a concave reflecting surface, the reflector 12 will present a convex reflecting surface and likewise if the curved combiner 50 presents a convex reflecting surface, the reflector 12 will present a concave reflecting surface. The reflector 12 can be provided by a curved mirror which can be advantageous as mirrors do not cause colour dispersion and have high efficiency.

Since a convex reflecting surface will diverge light which is incident upon it, it may also be used to set a smaller focus distance for the first image 32_1, such as 10 m instead of infinity. The convex reflecting surface can be used to set a finite focus distance even in the absence of a curved combiner 50.

In other examples, the image adjustment means 10 can comprise one or more additional optical elements (not shown), such as one or more lenses, disposed between the exit pupil expander 42 and the reflector 12, wherein the one or more additional optical elements are configured to provide compensation for the distorting effects of the curved combiner 50. In such examples, the reflector 12 can be planar rather than curved.

FIG. 5 illustrates an example of a display means 20 comprising a light guide 40. The light guide 40 in this example, but not necessarily all examples, comprises an in-coupling element 44 comprising diffractive means for receiving input light 34 defining the image 32 and an out-coupling element 48 comprising diffractive means configured to out-couple light 34_1, 34_2 defining the first and second images 32_1, 32_2.

Examples of diffractive means that may be used for the in-coupling element 44 and the out-coupling element 48 include but are not limited to diffraction gratings and other periodic structures.

The light guide 40 can be configured as an exit pupil expander 42 with an increased number of acceptable viewing positions for the user 2.

An example of a two-dimensional exit pupil expander is illustrated in FIG. 6 (and FIG. 7). FIG. 6 is a perspective view. FIG. 7 comprises three distinct views: (i) a top plan view, (ii) a first side view that defines a first dimension and (iii) a second side view that defines a second dimension.

The exit pupil expander 42 comprises an in-coupling element 44 configured to in-couple an input beam of light 34 into the light guide 40, an expanding element 46 configured to expand the input beam of light 34, and an out-coupling element 48 configured to out-couple two expanded beams of light 34_1, 34_2 from the light guide 40. In FIG. 6, for simplicity, only one of the out-coupled beams of light is shown.

Each of the in-coupling element 44, expanding element 46, and out-coupling element 48 can comprise diffractive means. Examples of diffractive means that may be used for the in-coupling element 44, the expanding element 46, and the out-coupling element 48 include but are not limited to diffraction gratings and other periodic structures.

A pupil is a virtual aperture. The input pupil is expanded (increased, multiplied) to form the larger exit pupil. In the example illustrated the exit pupil is expanded in two different dimensions.

In general, 2D exit pupil expanders use diffractive optics. However, a 1D exit pupil expander can use refracting optics, with slanted mirror surfaces (or prisms) inside the light guide 40. 2D expansion with refractive optics is possible but more difficult.

The light guide 40 could comprise a stack of multiple light guides, or partially overlapping light guides 40, or adjacent light guides 40. The term ‘light guide’ should be construed accordingly.

Glare or stray light may be caused by reflections on different surfaces, unwanted diffractions (e.g., of higher order) on the diffraction gratings, or some other comparable causes. Means for reducing such effects could be used. Examples include but are not limited to glare shields, anti-reflection coatings of different surfaces, and special diffraction grating solutions.

In the above examples, an exit pupil expander (EPE) head-up display (HUD) can consist of a standard EPE solution based on an optical engine 30, such as a PGU projector, and a diffractive light guide 40 with incoupler 44, expander 46, and outcoupler 48 gratings. Other types of EPE layouts are equally possible.

The first image 32_1 (see FIG. 8, which for simplicity shows only the first image 32_1) can be focused to infinity (using a flat light guide 40), or to a finite distance (using e.g., a spherical light guide 40 or a flat light guide 40 with a curved reflector 12 which more than counters any curvature of the combiner 50), or have multiple focal planes (using e.g., a stack of spherical light guides 40).

Only one EPE 42 is shown in all the examples and it could be enough for achieving full colours, decent exit pupil/eyebox size, and eye relief/viewing distance from the EPE HUD system. Nonetheless, the apparatus 100 can also use multiple EPEs 42 for multiplexing colours, the focal distance, the field of view (FOV), the exit pupil, or some other features.

Adjustment of the exit pupil position might be needed in order to compensate for user size or position. The adjustment could be of mechanical type (e.g., tilting.) or of some other type, automatic or manual, and could, in the case of configuring the apparatus 100 as a vehicle head-up display, be synced with the vehicles seat, steering wheel, or some other adjustment available in a vehicle. The adjustment could move the positions of the first area 6_1, the second area 6_2, and the third area 6_3 on the viewing plane 6.

FIGS. 11A to 15C illustrate examples of different methods of adaptively cropping the second area 6_2. Any one or more of these examples can be applied to adaptively crop the second area 6_2. More than one of these examples may be applied simultaneously. FIGS. 9A to 10C provide context for the manner in which these examples are illustrated. For simplicity, the reflector 12 and the combiner 50 are not shown. It should also be noted that the relative scale of various features has been exaggerated. These FIGs are provided to aid the following description rather than as an accurate depiction of the apparatus 100 in operation.

In FIG. 9A, the recycled light 34_1 is shown in solid lines which represent constituent light rays. As the reflector 12 and combiner 50 are omitted for simplicity, these are shown as following direct paths from the EPE 42 to the viewing plane 6. On the other hand, the forward directed light 34_2 is shown in dashed lines which represent constituent light rays. These are offset from the EPE 42 to represent the different path by which they approach the viewing plane 6.

FIG. 9B illustrates what is simultaneously occurring within the EPE 42, as described in relation to FIGS. 5 to 8.

FIG. 9C illustrates the image observed by the user 2 whose eye(s) 4 are within the first area 6_1, as shown in FIG. 9A. The user 2 observes all of the first image 32_1 and none of the second image 32_2.

In FIG. 10A it can be seen that the user's eye(s) 4 have moved upwards out of the first area 6_1. There is no change in the out-coupled light 34_1, 34_2 nor in the functioning of the EPE 42 (FIG. 10B). However, because the position of the eye(s) 4 of the user 2 have moved outside of the first area 6_1, vignetting of the first image 32_1 occurs from the user's perspective. The user 2 sees only a partial first image 32_1′. Also, because the user's eye(s) 4 have moved into the second area 6_2 and thus into a position reached by forward directed light 34_2, the user 2 sees at least a partial second image 32_2′. In particular the partial second image 32_2′ may comprise image content which is missing from the partial first image 32_1′. The image adjustment provided by the image adjustment means 10 has not been applied to this partial second image 32_2′. In the illustrated example, the image adjustment means 10 is configured to compensate for the distorting effects of a curved combiner 50 and thus the partial second image 32_2′, to which this compensation is not applied, appears distorted from the user's perspective. Because the partial second image 32_2′ reaches the viewing plane 6 in a different location to a corresponding part of the first image 32_1, it will also appear out of registration with the environment in augmented reality applications.

FIG. 11A illustrates a first example of a method of adaptively cropping the second area 6_2. In this example, the image 32 for in-coupling into the exit pupil expander 42, via in-coupling element 44, is adaptively cropped in response to the user's eye position moving outside of the first area 6_1.

Cropping of the in-coupled image 32 can be achieved by controlling the image content (pixel data) that is provided to the optical engine 30. An advantage of this method is that original image content can be re-arranged so that while the image area may be cropped, all image content may be retained.

Cropping of the in-coupled image 32 can be achieved by controlling the pixel on/off state of the optical engine 30.

Cropping of the in-coupled image 32 can be achieved by an adaptive spatial filter, such as for example an electromechanically movable physical absorber element, disposed between the light source and the optics of the optical engine 30.

A-priori information on the extent of the image 32 to be cropped for a given position of the eye(s) 4 of the user 2 may be stored in a memory 204 (FIG. 18) of a controller 200 suitable for use in the apparatus 100. The a-priori information may be derived from experimental data, theoretical modelling, or a combination thereof. The a-priori information may be stored in a lookup table in association with different eye positions. Accordingly, the position of the eye(s) 4 of the user 2 may be used as an index to the lookup table to extract the information on the extent to which the image 32 is to be cropped. The cropping of the image 32 can be accordingly adapted.

No change to the functioning of the EPE 42 is required (FIG. 11B).

By cropping the in-coupled image 32, light which could have followed a path, via forward out-coupling from the EPE 42, to the user's eye position is no longer in-coupled into the EPE 42 and accordingly does not reach the user's eye(s) 4. The user 2 therefore observes the partial first image 32_1′ and none of the second image 32_2 (FIG. 11C).

FIGS. 12A to 13C illustrate second and third examples of adaptively cropping the second area 6_2, both of which comprise adaptively reducing an exit pupil expansion provided by the exit pupil expander 42.

In the example of FIGS. 12A to 12C, the exit pupil expansion provided by the exit pupil expander 42 is reduced by adaptively reducing an effective area of the out-coupling element 48 of the exit pupil expander 42. As illustrated in FIG. 12B, the image 32 can be out-coupled at positions within the effective area 48_1 of the out-coupling element 48, whereas the image 32 cannot be out-coupled at any positions within the ineffective area 48_2.

The effective area 48_1 of the out-coupling element 48 can be reduced by disabling certain areas of the out-coupling element 48. This can be achieved by the use of switchable gratings to provide the out-coupling element 48. Switchable gratings comprise individual gratings or sets/groups of gratings which are independently switchable between at least a first state (“ON” state) in which their diffractive efficiency is above a threshold and a second state (“OFF” state) in which their diffractive efficiency is below a threshold. Any suitable switchable grating and mechanism for switching gratings ON and OFF may be used, not least for example switchable surface relief gratings, switchable volume holographic gratings, or switchable Bragg gratings.

In the example of FIGS. 13A to 13C, the exit pupil expansion provided by the exit pupil expander 42 is reduced by adaptively reducing an effective area of the expanding element 46 of the exit pupil expander 42. As illustrated in FIG. 13B, the image 32 can be directed into the out-coupling element 48 at positions within the effective area 46_1 of the expanding element 46, whereas the image 32 cannot be directed into the out-coupling element 48 at any positions within the ineffective area 46_2. Accordingly, there are positions within the out-coupling element 48 which are not reached by the image 32 and thus at which the image 32 is not out-coupled.

The effective area 46_1 of the expanding element 46 can be reduced by disabling certain areas of the expanding element 46. This can be achieved by the use of switchable gratings to provide the expanding element 46.

A-priori information on which areas should be disabled for a given position of the eye(s) 4 of the user 2 may be stored in a memory 204 (FIG. 18) of a controller 200 suitable for use in the apparatus 100. The a-priori information may be derived from experimental data, theoretical modelling, or a combination thereof. The a-priori information may be stored in a lookup table in association with different eye positions. Accordingly, the position of the eye(s) 4 of the user 2 may be used as an index to the lookup table to extract the information on areas to be disabled. The reduction of effective areas of these elements 46, 48 can be accordingly adapted.

By preventing out-coupling at positions from which forward directed light 34_2 could have followed a path to the user's eye position, no part of the second image 32_2 reaches the user's eye(s) 4. The user 2 therefore observes the partial first image 32_1′ and none of the second image 32_2 (FIG. 12C, FIG. 13C).

FIGS. 14A to 15C illustrate fourth and fifth examples of adaptively cropping the second area 6_2, both of which comprise applying an adaptive spatial filter 60 between the exit pupil expander 42 and the viewing plane 6.

The adaptive spatial filter 60 is a spatially selective filter. The adaptive spatial filter 60 is configured to limit the paths for light 34_1, 34_2 to reach the viewing plane 6 to those paths which pass through a selectable area. The adaptive spatial filter 60 blocks those paths which do not pass through this area.

In the example of FIG. 14A to 14C, the adaptive spatial filter is provided by an electromechanically movable physical absorber element 62 which is positioned in front of the EPE 42.

A-priori information on the position into which the physical absorber element 62 should be moved for a given position of the eye(s) 4 of the user 2 may be stored in a memory 204 (FIG. 18) of a controller 200 suitable for use in the apparatus 100. The a-priori information may be derived from experimental data, theoretical modelling, or a combination thereof. The a-priori information may be stored in a lookup table in association with different eye positions. Accordingly, the position of the eye(s) 4 of the user 2 may be used as an index to the lookup table to extract the information on the position into which the physical absorber element 62 should be moved. The spatial filtering can be accordingly adapted.

In the example of FIG. 15A to 15C, the adaptive spatial filter is provided by a liquid crystal (LC) shutter 64 which is positioned in front of the EPE 42. Areas of the LC shutter 64 can be turned opaque to block the path of light therethrough.

A-priori information on the one or more areas of the LC shutter 64 that should be turned opaque for a given position of the eye(s) 4 of the user 2 may be stored in a memory 204 (FIG. 18) of a controller 200 suitable for use in the apparatus 100. The a-priori information may be derived from experimental data, theoretical modelling, or a combination thereof. The a-priori information may be stored in a lookup table in association with different eye positions. Accordingly, the position of the eye(s) 4 of the user 2 may be used as an index to the lookup table to extract the information on which one or more areas of the LC shutter 64 should be turned opaque. The spatial filtering can be accordingly adapted.

No change to the functioning of the EPE 42 is required (FIG. 14B, FIG. 15B).

By blocking forward directed light 34_2 which is following a path directed towards the user's eye position, no part of the second image 32_2 reaches the user's eye(s) 4. The user 2 therefore observes the partial first image 32_1′ and none of the second image 32_2 (FIG. 14C, FIG. 15C).

FIG. 16 illustrates a method of reducing the amount of forward directed light 34_2 which reaches the viewing plane 6 and which can be used in addition to the adaptive cropping of the second area 6_2.

In this example, the optical engine 30 may be configured to project the image 32 into the EPE 42 using highly polarised light 34. For illustrative purposes, the light 34 is depicted as being p-polarised.

A polarisation control element 70 that, when enabled, allows the passage of s-polarized light, but blocks p-polarized light (in the illustrated example, but can be reversed in other examples) is provided in front of the EPE 42. Accordingly, p-polarised forward directed light 34_2 can be blocked.

A half-wave plate 72 provided between the reflector 12 and the EPE 42 in such an orientation where the polarisation of the light passing through it twice gets rotated by 90 degrees. As a result, the recycled light 34_1 is s-polarised in the illustrated example and can pass through the polarisation control element 70 and onwards towards the viewing plane 6. The polarisation of light 34_3 undergoing second order reflections between the reflector 12 and the exit pupil expander 42 is rotated by 180 degrees and therefore remains p-polarised. Light 34_3 which has undergone second order reflections between the reflector 12 and the exit pupil expander 42 is therefore also blocked by the polarisation control element 70.

The polarisation control element 70 can be a LC shutter and could be the same LC shutter 64 as used in the example of FIGS. 15A to 15C.

In certain embodiments of any of the examples illustrated in FIGS. 11A to 15C, the user 2 might still be able to observe some part(s) of the second image 32_2 even after adaptively cropping the second area 6_2. The position and size of observable part(s) of the second image 32_2 can be designed to be located substantially off-axis and with small angular coverage so that there is no visibility near the central field of vision.

FIG. 17 illustrates an example of a method 300 for projecting visible light 34, forming an image 32, towards a viewing plane 6 for a user 2.

The method 300 optionally comprises, at block 302, obtaining a position of the eye(s) 4 of the user 2.

The method 300 comprises, at block 304, adaptively cropping the second area 6_2 in response to a position of the eye(s) 4 of the user 2 moving outside of the first area 6_1.

Block 304 can comprise at least one of the following: adaptively cropping the image 32 for in-coupling into the EPE 42 (FIG. 11A to 11C); adaptively reducing an exit pupil expansion provided by the EPE 42 (FIG. 12A to 12C and/or FIG. 13A to 13C); or applying an adaptive spatial filter 60 between the EPE 42 and the viewing plane 6 (FIG. 14A to 14C and/or FIG. 15A to 15C).

The means for adaptively cropping the second area 6_2 in response to a position of the eye(s) 4 of the user 2 moving outside of the first area 6_1 can comprise a controller 200 configured to perform the method 300.

The means for adaptively cropping an image 32 for in-coupling into the EPE 42 may, in addition to the controller 200, comprise at least one of the following: the optical engine 30 controllable by the controller 200; or an adaptive spatial filter disposed between the light source and the optics of the optical engine 30 and controllable by the controller 200.

The means for adaptively reducing an exit pupil expansion provided by the EPE 42 may comprise at least one of the following: means for adaptively reducing an effective area of the expanding element 46 of the EPE 42; or means for adaptively reducing an effective area of the out-coupling element 48 of the EPE 42. The means for adaptively reducing an effective area of the expanding element 46 of the EPE 42 may, in addition to the controller 200, comprise switchable gratings providing the expanding element 46 which are controllable by the controller 200. The means for adaptively reducing an effective area of the out-coupling element 48 of the EPE 42 may comprise, in addition to the controller 200, switchable gratings providing the out-coupling element 48 which are controllable by the controller 200.

The means for applying an adaptive spatial filter 60 between the EPE 42 and the viewing plane 6 may, in addition the controller 200, comprise the adaptive spatial filter 60 which is controllable by the controller 200.

FIG. 18 illustrates an example of a controller 200 suitable for use in the apparatus 100. Implementation of a controller 200 may be as controller circuitry. The controller 200 may be implemented in hardware alone, have certain aspects in software including firmware alone or can be a combination of hardware and software (including firmware).

As illustrated in FIG. 18 the controller 200 may be implemented using instructions that enable hardware functionality, for example, by using executable instructions of a computer program 206 in a general-purpose or special-purpose processor 202 that may be stored on a computer readable storage medium (disk, memory etc) to be executed by such a processor 202.

The processor 202 is configured to read from and write to the memory 204. The processor 202 may also comprise an output interface via which data and/or commands are output by the processor 202 and an input interface via which data and/or commands are input to the processor 202.

The memory 204 stores a computer program 206 comprising computer program instructions (computer program code) that controls the operation of the apparatus 100 when loaded into the processor 202. The computer program instructions, of the computer program 206, provide the logic and routines that enables the apparatus to perform the methods illustrated in the accompanying FIGs. The processor 202 by reading the memory 204 is able to load and execute the computer program 206.

The controller 200 comprises:
at least one processor 202; and
at least one memory 204 including computer program code,
the at least one memory 204 and the computer program code configured to, with the at least one processor 202, cause the apparatus 100 at least to perform:
adaptively cropping the second area 6_2 in response to a position of the eye(s) 4 of the user 2 moving outside of the first area 6_1.

The at least one memory 204 and the computer program code may be configured to, with the at least one processor 202, cause the apparatus 100 to perform obtaining a position of the eye(s) 4 of the user 2.

The controller 200 comprises:
at least one processor 202; and
at least one memory 204 storing instructions that, when executed by the at least one processor 202, cause the apparatus 100 at least to:
adaptively crop the second area 6_2 in response to a position of the eye(s) 4 of the user 2 moving outside of the first area 6_1.

The instructions may, when executed by the at least one processor 202, cause the apparatus 100 to obtain a position of the eye(s) 4 of the user 2.

As illustrated in FIG. 19, the computer program 206 may arrive at the apparatus 100 via any suitable delivery mechanism 208. The delivery mechanism 208 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 206. The delivery mechanism may be a signal configured to reliably transfer the computer program 206. The apparatus 100 may propagate or transmit the computer program 206 as a computer data signal.

Computer program instructions for causing the apparatus 100 to perform at least the following or for performing at least the following:
obtaining a position of the eye(s) 4 of the user 2; and
causing adaptive cropping of the second area 6_2 in response to a position of the eye(s) 4 of the user 2 moving outside of the first area 6_1.

The computer program instructions may be comprised in a computer program, a non-transitory computer readable medium, a computer program product, a machine readable medium. In some but not necessarily all examples, the computer program instructions may be distributed over more than one computer program.

Although the memory 204 is illustrated as a single component/circuitry it may be implemented as one or more separate components/circuitry some or all of which may be integrated/removable and/or may provide permanent/semi-permanent/dynamic/cached storage.

Although the processor 202 is illustrated as a single component/circuitry it may be implemented as one or more separate components/circuitry some or all of which may be integrated/removable. The processor 202 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGs may represent steps in a method and/or sections of code in the computer program 206. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The apparatus 100 can be a device, a module, or a system. As used here ‘module’ refers to a unit or apparatus that excludes certain parts/components that would be added by an end manufacturer or a user.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “obtain/obtaining” (and grammatical variants thereof) can include, not least: calculating, computing, processing, deriving, measuring, investigating, identifying, looking up (for example, looking up in a table, a database or another data structure), ascertaining and the like. Also, “obtaining” can include receiving (for example, receiving information), accessing (for example, accessing data in a memory), determining and the like. Also, “obtain/obtaining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-15. (canceled)

16. An apparatus comprising:
image adjustment means comprising a reflector;
display means comprising an exit pupil expander comprising an out-coupling element configured to out-couple a first image to the image adjustment means and also to out-couple a second image toward a viewing plane,
wherein the reflector is configured to reflect the first image towards the viewing plane,
wherein an angle between the reflector and the out-coupling element is configured to direct the first image into a first area of the viewing plane and to direct light for at least partially constructing the second image into a second area of the viewing plane, the second area being outside of the first area; and
means for adaptively cropping the second area in response to a user's eye position moving outside of the first area.

17. The apparatus of claim 16, wherein the means for adaptively cropping the second area comprises means for at least one of the following:
adaptively cropping an image for in-coupling into the exit pupil expander;
adaptively reducing an exit pupil expansion provided by the exit pupil expander; or
applying an adaptive spatial filter between the exit pupil expander and the viewing plane.

18. The apparatus of claim 17, wherein the means for adaptively reducing an exit pupil expansion provided by the exit pupil expander comprises means for at least one of the following:
adaptively reducing an effective area of an expanding element of the exit pupil expander; or
adaptively reducing an effective area of the out-coupling element of the exit pupil expander.

19. The apparatus of claim 16, wherein an extent of the cropping of the second area is dependent on the user's eye position.

20. The apparatus of claim 16, wherein the second area is cropped to exclude the user's eye position.

21. The apparatus of claim 16, wherein the reflector is configured to reflect the first image back through the exit pupil expander towards the viewing plane.

22. The apparatus of claim 16, wherein the image adjustment means is configured to provide optical adjustment of the first image.

23. The apparatus of claim 16, wherein the image adjustment means is configured to compensate for distorting effects produced by a curved combiner used to reflect the first and second images toward the first and second areas respectively.

24. The apparatus of claim 23, wherein the reflector is curved to provide compensation for the distorting effects.

25. The apparatus of claim 23, wherein the image adjustment means comprises one or more additional optical elements disposed between the exit pupil expander and the reflector, wherein the one or more additional optical elements are configured to provide compensation for the distorting effects.

26. The apparatus of claim 16, wherein the angle between the reflector and the out-coupling element is configured to direct second and higher order reflections between the reflector and the exit pupil expander into a third area of the viewing plane, the third area being outside the first area, and
the means for adaptively cropping the second area are also configured to adaptively crop the third area in response to a user's eye position moving outside of the first area.

27. The apparatus of claim 16, comprising means for obtaining or determining the user's eye position.

28. The apparatus of claim 16 configured as an exit pupil expander head-up display or a vehicle head-up display, wherein the display means comprises an optical engine and a combiner.

29. A method comprising:
in response to a user's eye position moving outside of a first area into which a first image is directed, adaptively cropping a second area of a viewing plane into which light for at least partially constructing a second image is directed, the second area being outside of the first area,
wherein the first and second images are out-coupled in different directions from an exit pupil expander and are both directed towards the viewing plane, and wherein an image adjustment is applied to the first image.

30. A computer program comprising instructions which, when executed by an apparatus, causes the apparatus to perform at least the following:
in response to a user's eye position moving outside of a first area into which a first image is directed, adaptively cropping a second area of a viewing plane into which light for at least partially constructing a second image is directed, the second area being outside of the first area,
wherein the first and second images are out-coupled in different directions from an exit pupil expander and are both directed towards the viewing plane, and wherein an image adjustment is applied to the first image.

31. An apparatus comprising:
at least one processor; and
at least one memory storing instructions that, when executed by the at least one processor, cause the apparatus at least to perform at least:
in response to a user's eye position moving outside of a first area into which a first image is directed, adaptively cropping a second area of a viewing plane into which light for at least partially constructing a second image is directed, the second area being outside of the first area,
wherein the first and second images are out-coupled in different directions from an exit pupil expander and are both directed towards the viewing plane, and wherein an image adjustment is applied to the first image.
